(19) United States
(12) Patent Application Publication
(10) Pub. No.: US 2024/0282476 A1
(43) Pub. Date: Aug. 22, 2024

(54) COMMUNICATION CABLE AND WIRE HARNESS USING SAME

(71) Applicant: Yazaki Corporation, Tokyo (JP)

(72) Inventor: Taketo KUMADA, Shizuoka (JP)

(73) Assignee: Yazaki Corporation, Tokyo (JP)

(21) Appl. No.: 18/413,601

(22) Filed: Jan. 16, 2024

Related U.S. Application Data
(63) Continuation of application No. PCT/JP23/05422, filed on Feb. 16, 2023.

(51) Int. Cl. H01B 3/44; H01B 3/30; H01B 7/00; H01B 7/02; H01B 7/18; H01B 7/295; H01B 11/12

(52) U.S. Cl. CPC H01B 3/441; H01B 3/308; H01B 7/0045; H01B 7/0216; H01B 7/0291; H01B 7/187; H01B 7/295; H01B 11/12

(57) ABSTRACT

A communication cable includes an insulation electric wire including a conductor having tensile strength of 400 MPa or more and a cross-sectional area of 0.22 mm² or less and a covering layer covering the conductor and being formed of an insulating material, and a sheath covering an outer periphery of the insulation electric wire and being formed of a resin composition containing crystalline polyolefin. A tensile elastic modulus of the sheath is 500 MPa or less, and a mass increase rate of the sheath is less than 50 mass % in a plasticizer migration test involving exposure in an atmosphere at 105° C. for 3,000 hours. Characteristic impedance of the communication cable is 100±10Ω.

### CROSS-REFERENCE TO RELATED APPLICATIONS

The present application is a continuation of International Application No. PCT/JP2023/005422, filed on Feb. 16, 2023, and is based on Japanese Patent Application No. 2021-205278, filed on Dec. 17, 2021, the entire contents of which are incorporated herein by reference.

### TECHNICAL FIELD

The present application relates to a communication cable and a wire harness using the same.

### BACKGROUND

In a case of a two-core differential transmission cable, for example, a cable used for Ethernet communication, stringent control of characteristic impedance is required. Japanese Unexamined Patent Application Publication No. 2017-188436 discloses a communication cable in which an insulation electric wire is covered with a sheath formed of a polypropylene resin.

### SUMMARY OF THE INVENTION

A polyvinyl chloride (PVC) resin is commonly used as an insulating material for a general electric wire converged around a communication cable. When exposed in a high-temperature atmosphere for an extended period, a plasticizer contained in the PVC tends to bleed out and migrate to a sheath of the communication cable. Thus, the plasticizer penetrates the sheath of the communication cable, and adheres to an additive that improves heat resistance of the insulating resin covering a wire core. As a result, there may be a risk of accelerating degradation of the insulating resin and reducing a communication speed of the communication cable.

Therefore, it has been known that a material having high crystallinity is generally used as a sheath material to suppress migration of a plasticizer. However, with such a resin composition, there is a tendency for a communication cable to become rigid and less flexible. In a vehicle, a bundle of insulation electric wires is reduced in size to perform routing in a narrow space, and hence a communication cable having high flexibility and an excellent communication property is required.

Meanwhile, there is required a communication cable that is less likely to break due to a tensile stress applied at the time of routing of a wire harness or assembling to a vehicle. In a case of a thin cable, there is a problem that the cable itself breaks or the cable is disconnected from a connector. Thus, a conductor having high breakage strength is used as a countermeasure. However, the cable itself tends to be rigid, and hence it is effective to use a flexible sheath material.

An object of the present application is to provide a communication cable that has high flexibility and an excellent communication property and is not likely to cause degradation of a transmission property by suppressing migration of a plasticizer from another member even in a high-temperature atmosphere for an extended period, and a wire harness using the same.

A communication cable according to an aspect of the present application includes an insulation electric wire including a conductor having tensile strength of 400 MPa or more and a cross-sectional area of 0.22 mm² or less and a covering layer covering the conductor and being formed of an insulating material, and a sheath covering an outer periphery of the insulation electric wire and being formed of a resin composition containing crystalline polyolefin. A tensile elastic modulus of the sheath is 500 MPa or less, a mass increase rate of the sheath is less than 50 mass % in a plasticizer migration test involving exposure in an atmosphere at 105° C. for 3,000 hours, and characteristic impedance of the communication cable is 100±10Ω.

A wire harness according to an aspect of the present application includes the above-mentioned communication cable and a polyvinyl chloride electric wire, wherein the communication cable and the polyvinyl chloride electric wire are bundle together.

According to the present application, it is possible to provide a communication cable that has high flexibility and an excellent communication property and is not likely to cause degradation of a transmission property by suppressing migration of a plasticizer from another member even in a high-temperature atmosphere for an extended period, and a wire harness using the same.

### BRIEF DESCRIPTION OF DRAWINGS

FIG. 1 is a cross-sectional view schematically illustrating one example of a communication cable (circular compression conductor) according to the present embodiment.

FIG. 2 is a cross-sectional view schematically illustrating one example of the communication cable (circular conductor) according to the present embodiment.

FIG. 3 is a perspective view schematically illustrating one example of a wire harness according to the present embodiment.

FIG. 4 is a side view schematically illustrating one example of the communication cable according to the present embodiment.

FIG. 5 is a side view schematically illustrating one example of twisting of insulation electric wires according to the present embodiment.

FIG. 6 is a schematic diagram illustrating a state in which characteristic impedance and an insertion loss are measured by using a vector network analyzer (VNA).

FIG. 7 is a graph illustrating characteristic impedance of a communication cable in Example 1.

FIG. 8 is a graph illustrating characteristic impedance of a communication cable in Comparative Example 1.

FIG. 9 is a cross-sectional view schematically illustrating a test sample.

FIG. 10 is a graph illustrating a relationship between a frequency and an insertion loss of the communication cable in Example 1 before and after a plasticizer migration test.

FIG. 11 is a graph illustrating a relationship between a frequency and an insertion loss of the communication cable in Comparative Example 1 before and after a plasticizer migration test.

FIG. 12 is a schematic diagram for describing a method of measuring flexibility of the communication cable.

FIG. 13 is a graph illustrating a relationship between flexibility and a DINP absorption amount of the communication cable with respect to a tensile elastic modulus of a sheath.

### DETAILED DESCRIPTION OF THE INVENTION

With reference to the drawings, a communication cable and a wire harness using the same according to an embodiment of the present application are described below in detail.

### [Communication Cable]

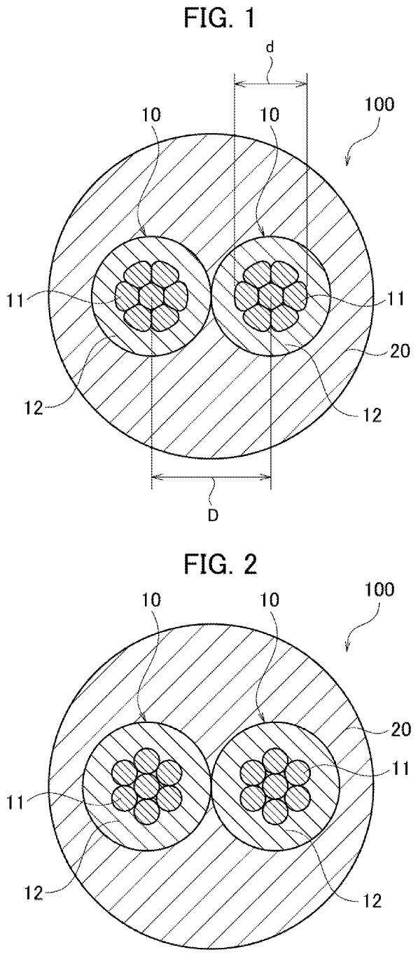

As illustrated in FIG. 1 and FIG. 2, a communication cable 100 includes an insulation electric wire 10 and a sheath 20 that covers the outer periphery of the insulation electric wire 10. The outer surface of the insulation electric wire 10 is directly covered with the sheath 20. The sheath 20 extends along an axial direction of the insulation electric wire 10. The thickness of the sheath 20 is not particularly limited, and may be from 0.1 mm to 1 mm, for example. In the present embodiment, two insulation electric wires 10 form a twist pair, but the number of insulation electric wire 10 may be at least one. Further, in the present embodiment, a gap may be provided between the insulation electric wire 10 and the sheath 20.

The sheath 20 contains a resin composition. Here, as described above, there may be a risk that, when a plasticizer added to polyvinyl chloride is used for an extended period, the plasticizer bleeds out to the surface and migrates to the sheath 20. In general, a dielectric tangent of the plasticizer is large, and a dielectric tangent of a phthalic acid-based plasticizer or a trimellitic acid-based plasticizer is particularly large. When the dielectric tangent is larger, an insertion loss of the communication cable 100 is increased, and this may hinder high-speed communication of the communication cable 100. Thus, not only when the resin composition forming the sheath 20 contains the plasticizer but also when the plasticizer migrates, there may be a risk of degrading a dielectric property of the sheath 20 and hindering high-speed communication.

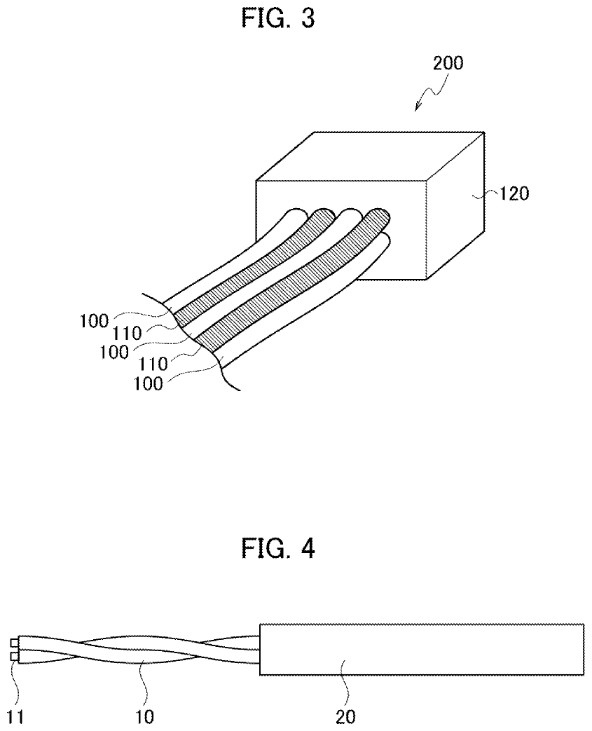

In view of this, in a plasticizer migration test in which the communication cable 100 according to the present embodiment and a polyvinyl chloride electric wire 110 are bundled together and left in an atmosphere at 105° C. for 3,000 hours, a mass increase rate of the sheath 20 is less than 50 mass %. The mass increase rate of the sheath 20 is less than 50 mass %, and hence migration of the plasticizer to the sheath 20 can be suppressed even when the communication cable 100 and the polyvinyl chloride electric wire 110 are bundled together to form a wire harness 200 as illustrated in FIG. 3. An amount of the plasticizer migrating to the sheath 20 is small, and hence a transmission property of the communication cable 100 is less likely to be degraded.

As a dielectric such as the resin composition of the sheath 20 has greater dielectric constant values and dielectric tangent values, and has a higher frequency, a high-frequency signal is attenuated more in the communication cable. In the present embodiment, the mass increase rate of the sheath 20 in the plasticizer migration test is less than 50 mass % to reduce the dielectric tangent and suppress attenuation. With this, communication in a high frequency band is enabled. In the communication cable 100 according to the present embodiment, a preferred transmission speed is 1 Gbps or less. Further, in the present embodiment, the mass increase rate of the sheath 20 is small, and hence degradation of communication quality, such as attenuation, of the communication cable 100 can be suppressed for an extended period even when a usage environment is a vehicle. The mass increase rate of the sheath 20 is preferably less than 40 mass %, more preferably, less than 30 mass %. A smaller value for the mass increase rate of the sheath 20 is preferred, and hence the lower limit of the mass increase rate of the sheath 20 may be 0 mass % or more. The mass increase rate of the sheath 20 may be adjusted by a composition of the resin composition or the like described below.

In order to achieve the above-mentioned mass increase rate of the sheath 20, it is effective to use a material having high crystallinity, such as homopolypropylene, in the resin composition of the sheath 20. However, a tensile elastic modulus of the sheath 20 thus configured is high, and the communication cable 100 is not easily bent. Thus, routing of the communication cable 100 in a narrow region may be difficult.

Therefore, in the present embodiment, the tensile elastic modulus of the sheath 20 is 500 MPa or less. When the tensile elastic modulus of the sheath 20 is 500 MPa or less, the communication cable 100 can be easily curved. Thus, routing of the communication cable 100 in a narrow region is facilitated. The tensile elastic modulus of the sheath 20 may be adjusted by a composition of the resin composition or the like described below.

The tensile elastic modulus can be measured in accordance with the provisions of JIS K7161-1 (Plastics—Determination of Tensile Properties—Part 1: General Principles). Specifically, calculation can be performed by pulling the sheath 20 at a tensile speed of 50 mm/min at a room temperature of 20° C., based on Calculation Formula (1) given below.

$${E}_{t} = ( {σ}_{2} - {σ}_{1} ) / ( {ε}_{2} - {ε}_{1} ) \qquad ( 1 )$$

Note that, in the equation given above, Eₜ represents a tensile elastic modulus (Pa), σ₁ represents a stress (Pa) at a strain ε₁=0.0005, and σ₂ represents a stress (Pa) at a strain ε₂=0.0025.

The resin composition of the sheath 20 contains crystalline polyolefin and a thermoplastic elastomer. A content rate of the crystalline polyolefin with respect to a total of the crystalline polyolefin and the thermoplastic elastomer is preferably 55 mass % or more and 70 mass % or less. When the content rate of the crystalline polyolefin is 55 mass % or more, the mass increase rate of the sheath 20 is reduced more, the plasticizer is less likely to migrate to the sheath 20, and communication reliability of the communication cable 100 can be maintained for an extended period. When the content rate of the crystalline polyolefin is 70 mass % or less, the tensile elastic modulus of the sheath 20 is reduced more, and operability in routing the communication cable 100 is improved. The content rate of the crystalline polyolefin is further preferably 65 mass % or more and 70 mass % or less.

A content rate of the thermoplastic elastomer with respect to the total of the crystalline polyolefin and the thermoplastic elastomer is preferably 30 mass % or more and less than 45 mass %. When the content rate of the thermoplastic elastomer is 30 mass % or more, the tensile elastic modulus of the sheath 20 is reduced more, and operability in routing the communication cable 100 is improved. When the content rate of the thermoplastic elastomer is less than 45 mass %, the mass increase rate of the sheath 20 is reduced more, the plasticizer is less likely to migrate to the sheath 20, and communication reliability of the communication cable 100 can be maintained for an extended period. The content rate of the thermoplastic elastomer is further preferably 30 mass % or more and 35 mass % or less.

A specific dielectric constant of the resin composition of the sheath 20 is preferably 6 or less. In a communication cable installed in an automobile, predetermined characteristic impedance needs to be satisfied for achieving high-speed communication. The characteristic impedance depends not only on the specific dielectric constant of the dielectric such as the resin composition but also on the structure of the communication cable. Reduction in weight and size is required for a communication cable installed in an automobile. However, when the specific dielectric constant is large, a finish outer diameter of the insulation electric wire needs to be increased. When the specific dielectric constant of the resin composition is 6 or less, this is applicable to a communication cable including a conductor with the smallest diameter having a cross-sectional area of 0.13 sq (mm²), which is specified in ISO 21111-8. Further, the standard for the characteristic impedance of 100±10Ω that is required for the communication cable can be satisfied. The specific dielectric constant can be measured at a frequency of 10 GHz in an atmosphere at 30° C. by a cavity resonator method.

As described above, the specific dielectric constant can be adjusted as appropriate by a content amount of an inorganic filler contained in the resin composition of the sheath 20. The specific dielectric constant of the resin composition of the sheath 20 is further preferably 2.5 or greater and 4.0 or less. When the specific dielectric constant is 2.5 or greater, the thickness that facilitates manufacturing of the sheath 20 can be obtained while satisfying the standard specified in ISO 21111-8. Thus, production efficiency of the communication cable 100 can be improved. Further, when the specific dielectric constant of the resin composition is 4.0 or less, the sheath 20 can be reduced in size while preventing the outer diameter or the weight of the communication cable 100 from being excessively increased. The specific dielectric constant of the resin composition is further preferably 3.0 or greater and 3.5 or less.

The dielectric tangent of the resin composition of the sheath 20 is preferably 5×10⁻² or less. When the dielectric tangent of the resin composition is 5×10⁻² or less, increase of an insertion loss of the communication cable 100 can be suppressed. The dielectric tangent is preferably less than 8.0×10⁻³. A smaller value for the dielectric tangent is preferred, and hence the lower limit of the dielectric tangent is 0. The dielectric tangent can be measured at a frequency of 10 GHz in an atmosphere at 30° C. by the cavity resonator method.

The specific dielectric constant of the resin composition of the sheath 20 may be 2.5 or more and 4.0 or less, the dielectric tangent of the resin composition may be 5×10⁻² or less, and a conductor 11 may be a conductor of 0.13 sq (mm²) specified in ISO 21111-8. The communication cable 100 described above has a small diameter and a satisfactory a communication property, and hence can be used suitable as the communication cable 100 to be installed in a vehicle.

### (Crystalline Polyolefin)

The crystalline polyolefin is a polymer of monomers containing olefins. The polyolefin may be a polymer of olefins alone, or may be a copolymer of olefins and a monomer other than olefins (for example, an ethylene-vinyl acetate copolymer (EVA)). The copolymer of olefins alone may be a copolymer of olefins of a single type, or may be a copolymer of olefins of two or more types. The polyolefin may be modified with maleic acid, or may not be modified.

The olefin may include α-olefin, β-olefin, γ-olefin, and the like. α-olefin may include at least one monomer selected from a group consisting of ethylene, propylene, 1-butene, 1-pentene, 1-hexene, 4-methyl-1-pentene, 1-octene, 1-decene, and the like.

The monomer other than olefins may be a monomer having a carbon-carbon double bond. The monomer other than olefins may include at least any one of styrene and acrylate.

The crystalline polyolefin may be at least one selected from a group consisting of low-density polyethylene (LDPE), linear low-density polyethylene (LLDPE), high-density polyethylene (HDPE), homopolypropylene (homo PP), random polypropylene (random PP), block polypropylene (block PP), ethylene-propylene-butene copolymer, and the like.

### (Thermoplastic Elastomer)

The thermoplastic elastomer is a resin having crystallinity lower than that of the crystalline polyolefin. The thermoplastic elastomer may contain at least one elastomer selected from a group consisting of an olefin-based thermoplastic elastomer (TPO), a thermoplastic vulcanizate (TPV), and a styrene-based thermoplastic elastomer (TPS). The thermoplastic elastomer may be modified with maleic acid, or may not be modified.

The olefin-based thermoplastic elastomer (TPO) is a mixture of a polyolefin and rubber, and the rubber in the mixture has no cross-linking points or very few cross-linking points. The polyolefin described above may be used. Examples of the rubber used in the olefin-based thermoplastic elastomer (TPO) include natural rubber (NR), isoprene rubber (IR), butadiene rubber (BR), styrene-butadiene copolymer rubber (SBR), acrylonitrile-butadiene copolymer rubber (NBR), chloroprene rubber (CR), butyl rubber (IIR), ethylene-propylene rubber (EPM), ethylene-propylene-diene rubber (EPDM), and the like.

Examples of the olefin-based thermoplastic elastomer include “Prime TPO (registered trademark)” available from Prime Polymer Co., Ltd.

The thermoplastic vulcanizate is a mixture of the polyolefin and the rubber, and the mixed rubber is cross-linked through dynamic vulcanization. As the rubber, the rubber used in the olefin-based thermoplastic elastomer described above may be used. The thermoplastic vulcanizate exhibits both features of being less likely to expand due to high-crystallinity resins such as ethylene and homopolypropylene and flexibility like rubber.

Examples of the thermoplastic vulcanizate include “THERMORUN (registered trademark)” available from Mitsubishi Chemical Corporation, “MILASTOMER (registered trademark)” available from Mitsui Chemicals, Inc., “EXCELINK (registered trademark)” available from JSR Corporation, “ESPOLEX (registered trademark) TPE series)” available from Sumitomo Chemical Co., Ltd., “Santoprene (registered trademark)” available from Exxon Mobil Corporation, and the like.

The styrene-based thermoplastic elastomer (TPS) may be a block copolymer or a random copolymer that has an aromatic vinyl-based polymer block (hard segment) and a diene-based polymer block (soft segment). Monomers forming the aromatic vinyl-based polymer may be styrene, α-position substituted styrene such as α-methylstyrene, α-ethylstyrene, α-methyl-p-methylstyrene, o-methylstyrene, m-methylstyrene, p-methylstyrene, 2,4-dimethylstyrene, ethylstyrene, 2,4,6-trimethylstyrene, o-t-butylstyrene, p-t-butylstyrene, and the like. The diene-based polymer block may be a copolymer of at least one of butadiene and isoprene, or may be obtained by hydrogenating part of the copolymer.

The styrene-based thermoplastic elastomer (TPS) may be a block copolymer of at least one type selected from a group consisting of polystyrene-polybutadiene-polystyrene (SBS), polystyrene-polyisoprene-polystyrene (SIS), polystyrene-polyisobutylene-polystyrene (SIBS), polystyrene-poly(ethylene-butylene)-polystyrene (SEBS), polystyrene-poly(ethylene-butylene)-crystalline polyolefin (SEBC), and polystyrene-poly(ethylene-propylene)-polystyrene (SEPS).

Examples of the styrene-based thermoplastic elastomer include “TEFABLOC (registered trademark)” available from Mitsubishi Chemical Corporation, “ESPOLEX (registered trademark) SB series” available from Sumitomo Chemical Co., Ltd., “SEPTON (registered trademark)” available from KURARAY Co., Ltd., “DYNARON (registered trademark)” available from JSR Corporation, “HYBRAR (registered trademark)” available from KURARAY Co., Ltd., and the like.

In addition to the crystalline polyolefin and the thermoplastic elastomer, various additives may be blended by an appropriate amount in the resin composition of the sheath 20 without hindering the effects of the present embodiment. Examples of the additives include a flame retardant, an inorganic filler, a flame retardant promoter, an antioxidant, a processing promoter, a crosslinking agent, a metal deactivator (copper inhibitor), an aging inhibitor, a filler, a reinforcing agent, a UV absorber, a stabilizer, a plasticizer, pigments, dyes, colorants, an antistatic agent, a foaming agent, and the like.

### (Flame Retardant)

The flame retardant improves flame retardance of the sheath 20. Even when there is a fire in a vehicle, it is possible to suppress the spread of fire with the sheath 20 by improving flame retardance of the sheath 20. Thus, it is not necessarily required to provide flame retardance to a covering layer 12 of the insulation electric wire 10. However, in view of improving flame retardance, it is preferred that the flame retardant be also added to the covering layer 12.

For example, the flame retardant may be at least any one of an organic flame retardant or an inorganic flame retardant. As the organic flame retardant, a halogen-based flame retardant such as a bromine-based flame retardant and a chlorine-based flame retardant, and a phosphorus-based flame retardant such as phosphoric ester, condensed phosphoric ester, a cyclic phosphorus compound, and red phosphorus, or the like may be used. As the inorganic flame retardant, metal hydroxide at least one type selected from a group consisting of aluminum hydroxide, magnesium hydroxide, and calcium hydroxide may be used. Those flame retardants may be used alone, or a plurality of types thereof may be mixed and used. For example, the flame retardant may contain the organic flame retardant and the inorganic flame retardant.

The content amount of the flame retardant contained in the resin composition of the sheath 20 is preferably 5 parts by mass to 200 parts by mass, more preferably, 50 parts by mass to 160 parts by mass with respect to a total of 100 parts by mass of the crystalline polyolefin and the thermoplastic elastomer. When the content amount of the flame retardant falls within the above-mentioned range, flame retardance can be improved while maintaining the mechanical property of the resin composition.

As the organic flame retardant, at least a halogen-based flame retardant is preferably contained. The halogen-based flame retardant is capable of capturing hydroxyl radicals that promote the combustion of the resin composition of the sheath 20 and suppressing the combustion of the resin composition. For example, the halogen-based flame retardant may be a compound that has at least one halogen substituted in an organic compound, for example. Examples of the halogen-based flame retardant include a fluorine-based flame retardant, a chlorine-based flame retardant, a bromine-based flame retardant, and an iodine-based flame retardant. The halogen-based flame retardant is preferably the bromine-based flame retardant.

For example, the bromine-based flame retardant contains 1,2-bis(bromophenyl)ethane, 1,2-bis(pentabromophenyl)ethane, hexabromobenzene, ethylene bis-dibromonorbomanedicarboximide, ethylene bis-tetrabromophthalimide, tetrabromobisphenol S, tris(2,3-dibromopropyl-1)isocyanurate, hexabromocyclododecane (HBCD), octabromophenyl ether, tetrabromobisphenol A (TBA), a TBA epoxy oligomer or polymer, TBA-bis(2,3-dibromopropyl ether), decabromodiphenyl oxide, polydibromophenylene oxide, bis(tribromophenoxy)ethane, ethylene bis-pentabromobenzene, dibromoethyl-dibromocyclohexane, dibromo-neopentyl glycol, tribromophenol, tribromophenol allyl ether, tetradecabromodiphenyl ether, 2,2-bis(4-hydroxy-3,5-dibromophenyl)propane, 2,2-bis(4-hydroxyethoxy-3,5-dibromophenyl)propane, pentabromophenol, pentabromotoluene, pentabromodiphenyl oxide, hexabromodiphenyl ether, octabromodiphenyl ether, decabromodiphenyl ether, octabromodiphenyl oxide, dibromo-neopentyl glycol tetracarbonate, bis(tribromophenyl) fumarate amide, N-methyl hexabromophenyl amine, or the like. The flame retardant preferably contains 1,2-bis(pentabromophenyl)ethane and tetrabromobisphenol A. The flame retardant described above has a low specific dielectric constant, and hence flame retardance can be provided while suppressing increase of the viscosity and the specific dielectric constant of the resin composition.

the content amount of the halogen-based flame retardant contained in the resin composition of the sheath 20 is preferably 5 parts by mass to 40 parts by mass, more preferably, 10 to 30 parts by mass with respect to the total of 100 parts by mass of the crystalline polyolefin and the thermoplastic elastomer. When the content amount of the halogen-based flame retardant is 10 parts by mass or more, flame retardance of the resin composition can be improved. Further, when the content amount of the halogen-based flame retardant is 30 parts by mass or less, there is no need to use the flame retardant more than necessary while maintaining the mechanical property. As a result, a manufacturing cost of the resin composition can be reduced.

The content amount of the inorganic flame retardant contained in the resin composition of the sheath 20 is preferably 30 parts by mass to 200 parts by mass, preferably, 40 to 150 parts by mass with respect to the total of 100 parts by mass of the crystalline polyolefin and the thermoplastic elastomer. When the content amount of the inorganic flame retardant is 40 parts by mass or more, excessive reduction of the specific dielectric constant of the resin composition can be suppressed. When the content amount of the inorganic flame retardant is 150 parts by mass or less, excessive increase of the specific dielectric constant can be suppressed. Further, when the content amount of the inorganic flame retardant is 150 parts by mass or less, viscosity of the resin composition is reduced. As a result, processability of the resin composition can be improved.

As the inorganic flame retardant, at least metal hydroxide is preferably contained. The metal hydroxide is commonly used as a flame retardant, and is relatively cost-effective as compared to a bromine-based flame retardant. Further, the metal hydroxide has a high dielectric constant with respect to a typical polyolefin-based resin, and hence acts as a dielectric constant modifier. Thus, the resin composition of the sheath 20 according to the present embodiment preferably contains the metal hydroxide in addition to the halogen-based flame retardant. As the metal hydroxide, one or a plurality of metal compounds having hydroxyl groups or crystal water, such as magnesium hydroxide (Mg(OH)₂), aluminum hydroxide (Al(OH)₃), calcium hydroxide (Ca(OH)₂), basic magnesium carbonate (mMgCO₃·Mg(OH)₂·nH₂O), hydrated aluminum silicate (aluminum silicate hydrate, Al₂O₃·3SiO₂·nH₂O), and hydrated magnesium silicate (magnesium silicate pentahydrate, Mg₂Si₃O₈·5H₂O). Among those, magnesium hydroxide is particularly preferred as the metal hydroxide.

The resin composition of the sheath 20 further preferably contains 40 to 150 parts by mass of the metal hydroxide with respect to the total of 100 parts by mass of the crystalline polyolefin and the thermoplastic elastomer. When the content amount of the metal hydroxide is 40 parts by mass or more, excessive reduction of the specific dielectric constant of the resin composition can be suppressed, and flame retardance can also be improved. When the content amount of the metal hydroxide is 150 parts by mass or less, excessive increase of the specific dielectric constant can be suppressed, and flexibility of the resin composition can also be improved. Further, when the content amount of the metal hydroxide is 150 parts by mass or less, viscosity of the resin composition is reduced. As a result, processability of the resin composition can be improved. The resin composition may further contain 80 parts by mass or more of the metal hydroxide, and may further contain 100 parts by mass or less of the metal hydroxide with respect to the total of 100 parts by mass of the crystalline polyolefin and the thermoplastic elastomer.

When viscosity of the resin composition of the sheath 20 is high, extrusion processability of the resin composition can also be improved by reducing the content amount of the inorganic flame retardant and increasing the content amount of the organic flame retardant. When the flame retardant contains the organic flame retardant and the inorganic flame retardant, for example, a ratio of the inorganic flame retardant with respect to the organic flame retardant may be 0.75 to 40, or may be 1 to 10.

### (Inorganic Filler)

In order to adjust the dielectric constant of the resin composition of the sheath 20, the resin composition may include the inorganic filler. The inorganic filler may contain the inorganic flame retardant described above. Examples of the inorganic filler may include metal oxide compounds such as the metal hydroxide described above, aluminum oxide, and titanium dioxide, and titanate compounds such as barium titanate and strontium titanate.

The content amount of the inorganic filler contained in the resin composition of the sheath 20 is preferably 30 parts by mass to 200 parts by mass, preferably, 40 to 150 parts by mass with respect to the total of 100 parts by mass of the crystalline polyolefin and the thermoplastic elastomer. When the content amount of the inorganic filler is 30 parts by mass or more, excessive reduction of the specific dielectric constant of the resin composition can be suppressed. When the content amount of the inorganic filler is 150 parts by mass or less, excessive increase of the specific dielectric constant can be suppressed.

### (Flame Retardant Promoter)

The flame retardant promoter improves the resin composition of flame retardance of the sheath 20 together with the flame retardant. The flame retardant promoter may be, for example, antimony trioxide. When antimony trioxide is used together with the halogen-based flame retardant, flame retardance of the resin composition can be improved. The content amount of the flame retardant promoter contained in the resin composition is preferably 0.1 parts by mass to 30 parts by mass, more preferably, 1 parts by mass to 15 parts by mass with respect to the total of 100 parts by mass of the polyolefin and the thermoplastic elastomer.

### (Antioxidant)

For example, the antioxidant suppresses oxidation of the resin composition of the sheath 20. As the antioxidant, a publicly known antioxidant used in a thermoplastic resin may be used, including a radical chain inhibitor such as a phenol-based antioxidant, a hindered phenol-based antioxidant, and an amine-based antioxidant, a peroxide decomposer such as a phosphorus-based antioxidant and a sulfur-based antioxidant, and a metal deactivator such as a hydrazine-based antioxidant and an amine-based antioxidant. The antioxidant may be used alone, or a plurality of types thereof may be mixed and used.

An amount of the antioxidant to be added may be adjusted in consideration of an antioxidant effect and a malfunction due to bleed-out. The content amount of the antioxidant contained in the resin composition of the sheath 20 is preferably 0.5 parts by mass to 10 parts by mass with respect to the total of 100 parts by mass of the crystalline polyolefin and the thermoplastic elastomer. When the content amount of the antioxidant is 0.5 parts by mass or more, heat resistance can be improved. Further, when the content amount of the antioxidant is 10 parts by mass or less, bleed-out can be suppressed.

### (Processing Promoter)

The processing promoter is added to maintain die drool generated at the time of extrusion molding and a shape of an extruded object. The processing promoter may contain at least one of metal soap and a polymer lubricant. The content amount of the processing promoter contained in the resin composition of the sheath 20 is preferably 0.01 parts by mass to 10 parts by mass, more preferably, 0.1 parts by mass to 5 parts by mass with respect to the total of 100 parts by mass of the crystalline polyolefin and the thermoplastic elastomer.

The resin composition of the sheath 20 may further contain 40 to 150 parts by mass of the metal hydroxide and 10 to 30 parts by mass of the halogen-based flame retardant with respect to the total of 100 parts by mass of the crystalline polyolefin and the thermoplastic elastomer. The specific dielectric constant of the resin composition may be 6 or less, and the dielectric tangent of the resin composition may be 5×10⁻² or less. When the sheath 20 is formed of the resin composition described above, it is possible to provide the communication cable 100 that has higher flexibility and a further excellent communication property and is not likely to cause degradation of a transmission property by suppressing migration of a plasticizer from another member even in a high-temperature atmosphere for an extended period.

The communication cable 100 may be formed by a publicly known method, and may be produced by a general extrusion molding method, for example. Specifically, one or a plurality of insulation electric wires 10 are bundled, and then the material of the sheath 20 is extruded to cover the outer surface of the insulation electric wire 10. In this manner, the sheath 20 may be formed.

### (Insulation Electric Wire)

As illustrated in FIG. 1 and FIG. 2, the insulation electric wire 10 includes the conductor 11 and the covering layer 12 that covers the conductor 11 and is formed of the insulating material. The conductor 11 may be configured by one wire, or may be an assembly twisted wire formed by bundling a plurality of wires together. Further, the conductor 11 may be a circular compression conductor as illustrated in FIG. 1, or may be a circular conductor as illustrated in FIG. 2. The material forming the conductor 11 is not particularly limited, and is preferably at least one conductive metal material selected from a group consisting of copper, a copper alloy, aluminum, an aluminum alloy, and the like.

The tensile strength of the conductor 11 is 400 MPa or more. When the tensile strength of the conductor 11 is 400 MPa or more, the communication cable 100 is less likely to break due to a tensile stress applied at the time of routing of a wire harness or assembling to a vehicle. The tensile strength can be measured in accordance with the provisions of JIS Z2241 (Metallic materials—Tensile testing).

The outer diameter of the conductor 11 is not particularly limited, and is preferably 0.435 mm or more, more preferably, 0.440 mm or more. When the diameter of the conductor 11 is set as described above, a resistance of the conductor 11 can be reduced. Further, the diameter of the conductor 11 is not particularly limited, and is preferably 0.465 mm or less, more preferably, 0.460 mm or less. When the outer diameter of the conductor 11 is set as described above, routing of the insulation electric wire 10 can be facilitated even in a narrow and short path.

The cross-sectional area of the conductor 11 is preferably 0.22 mm² or less. When the cross-sectional area of the conductor 11 is 0.22 mm² or less, routing of the insulation electric wire 10 can be facilitated even in a narrow and short path. The conductor 11 is preferably a conductor of 0.13 sq (mm²) specified in ISO 21111-8.

Note that, when the insulation electric wire 10 forms a twist pair as illustrated in FIG. 4, the strength of the conductor can be obtained based on Calculation Formula (2) given below.

$$Strength of conductor ( N ) = Tensile strength ( MPa ) \times Cross ‐ sectional area of conductor ( {mm}^{2} ) \times 2 \qquad ( 2 )$$

The strength of the conductor 11 is preferably 100 N or more in consideration of reliability on quality. When the tensile strength of the conductor 11 is 400 MPa, and the cross-sectional area of the conductor 11 is 0.13 sq (mm²), 104 N is obtained based on Calculation Formula (2) given above.

The thickness of the covering layer 12 is not particularly limited, and is preferably 0.15 mm or more, more preferably, 0.18 mm or more. When the thickness of the covering layer 12 is set as described above, the conductor 11 can be effectively protected. Further, the thickness of the covering layer 12 is not particularly limited, and is preferably 0.32 mm or less. When the thickness of the covering layer 12 is set as described above, routing of the insulation electric wire 10 can be facilitated even in a narrow path.

Note that, when the insulation electric wire 10 forms a twist pair as illustrated in FIG. 4, the characteristic impedance can be calculated based on Equation 1 given below.

$${Z}_{0} = \frac{120}{\sqrt{{ε}_{e}}} ln \frac{D + \sqrt{{D}^{2} - {k}_{1}^{2} {d}^{2}}}{{k}_{1} d} \qquad [ Equation 1 ]$$

In Equation 1 given above, Zo represents characteristic impedance (Ω), εₑ represents an effective specific dielectric constant, and k₁ represents a conductor outer diameter coefficient. Further, as illustrated in FIG. 1, D represents a distance (mm) between the centers of the conductors 11, and d represents a diameter (mm) of the conductor 11.

In a case in which the conductor 11 is a conductor of 0.13 sq (mm²), when the characteristic impedance required for the communication cable is, for example, 100Ω, the thickness of the covering layer 12 is 0.20 mm, based on Equation 1 given above. Further, when the conductor 11 is a conductor of 0.22 sq (mm²), the thickness of the covering layer 12 is 0.26 mm. In other words, as the surface area of the conductor 11 is larger, the thickness of the covering layer is required to be larger.

The insulating material forming the covering layer 12 contains polypropylene and a flexible resin. In view of flexibility of the communication cable and operability of routing of the communication cable, the content rate of the polypropylene with respect to the total of the polypropylene and the flexible resin is preferably 51 mass % or more and 85 mass % or less.

The polypropylene may be at least one selected from a group consisting of homopolypropylene (homo PP), random polypropylene (random PP), block polypropylene (block PP), and the like.

In view of flexibility of the communication cable and operability in routing the communication cable 100, the content rate of the flexible resin with respect to the total of the polypropylene and the flexible resin is preferably 15 mass % or more and less than 49 mass %.

The flexible resin may contain a resin other than polypropylene among the above-mentioned crystalline polyolefin. Further, the flexible resin may contain the above-mentioned thermoplastic elastomer.

The specific dielectric constant of the insulating material forming the covering layer 12 is preferably 2.25 or greater and 3.5 or less. When the specific dielectric constant is 2.25 or greater, the thickness that facilitates manufacturing of the insulation electric wire 10 can be obtained while satisfying the standard specified in ISO 21111-8. As a result, production efficiency of the communication cable 100 can be improved. Further, when the specific dielectric constant of the insulating material is 3.5 or less, this is applicable to a communication cable including a conductor with the smallest diameter of 0.13 sq (mm²) specified in ISO 21111-8. Further, when the specific dielectric constant of the insulating material is 3.5 or less, excessive increase of the outer diameter and excessive increase of the weight of the communication cable 100 can be suppressed. The specific dielectric constant can be measured at a frequency of 10 GHz in an atmosphere at 30° C. by the cavity resonator method.

In addition to the polypropylene and the flexible resin, various additives contained in the above-mentioned resin composition of the sheath 20 may be blended by an appropriate amount in the insulating material forming the covering layer 12 without hindering the effects of the present embodiment. However, in view of a communication property, it is preferred that the insulating material does not contain a plasticizer.

In order to adjust the dielectric constant of the covering layer 12, the insulating material forming the covering layer 12 preferably contains titanium oxide as the inorganic filler. The insulating material preferably contains 15 to 60 parts by mass of titanium oxide with respect to the total of 100 parts by mass of the polypropylene and the flexible resin. When the content amount of titanium oxide is 15 parts by mass or more, excessive reduction of the specific dielectric constant of the insulating material can be suppressed. When the content amount of titanium oxide is 60 parts by mass or less, excessive increase of the specific dielectric constant of the insulating material can be suppressed.

The insulating material forming the covering layer 12 preferably contains 10 to 80 parts by mass of the bromine-based flame retardant with respect to the total of 100 parts by mass of the polypropylene and the flexible resin. When the content amount of the bromine-based flame retardant is 10 parts by mass or more, flame retardance of the insulating material can be improved. Further, when the content amount of the bromine-based flame retardant is 80 parts by mass or less, there is no need to use the flame retardant more than necessary while maintaining the mechanical property. As a result, a manufacturing cost of the insulating material can be reduced.

The insulating material forming the covering layer 12 preferably contains 0.1 parts by mass to 30 parts by mass of the flame retardant promoter, and more preferably contains 1 parts by mass to 15 parts by mass of the flame retardant promoter with respect to the total of 100 parts by mass of the polypropylene and the flexible resin. The flame retardant promoter may be antimony trioxide, for example. When antimony trioxide is used together with the bromine-based flame retardant, flame retardance of the insulating material can be improved.

The insulating material forming the covering layer 12 preferably contains less than 45 parts by mass of magnesium hydroxide with respect to the total of 100 parts by mass of the polypropylene and the flexible resin. When the content amount of magnesium hydroxide is less than 45 parts by mass, excessive increase of the specific dielectric constant can be suppressed, and flexibility of the insulating material can also be improved.

The insulating material forming the covering layer 12 preferably contains 0.5 parts by mass to 10 parts by mass of an antioxidant with respect to the total of 100 parts by mass of the polypropylene and the flexible resin. As the antioxidant, the antioxidant used in the resin composition of the sheath 20 may be used, for example. The antioxidant may be used alone, or a plurality of types thereof may be mixed and used.

The insulating material forming the covering layer 12 preferably contains 0.01 parts by mass to 10 parts by mass, more preferably, 0.1 parts by mass to 5 parts by mass of a processing promoter with respect to the total of 100 parts by mass of the polypropylene and the flexible resin. As the processing promoter, the processing promotor used in the resin composition of the sheath 20 may be used, for example.

The insulating material forming the covering layer 12 preferably contains 0.5 to 10 parts by mass of a metal deactivator (copper inhibitor) with respect to the total of 100 parts by mass of the polypropylene and the flexible resin. When the metal deactivator is used as the insulating material, a metal ion can be chelated. When the metal ion is captured to achieve stabilization, oxidation and degradation of the resin of the insulating material can be prevented. As the metal deactivator, an oxalic compound, an amide compound such as salicylic acid, or a hydrazide compound may be used. Further, the metal deactivator itself does not exert a stabilization effect, and hence a phenol-based antioxidant or the like is preferably used together in order to provide thermal stability.

As illustrated in FIG. 5, a twist pitch 151 of the two insulation electric wires 10 forming a twist pair is preferably 15 times or more or 45 times or less of the outer diameter of the insulation electric wire 10, more preferably, 15 times or more and 40 times or less of the outer diameter of the insulation electric wire 10. When the twist pitch 151 is 15 times or more, a stress applied to the center side of the twist is not excessively increased, and collapse of the insulating material forming the covering layer 12 and disturbance of the characteristic impedance can be prevented. Further, when the twist pitch 151 is 45 times or less, the twist pitch 151 is stabilized, and degradation of characteristics of mode conversion relating to emission or resistance to electrical noise can be prevented.

As illustrated in FIG. 5, the twist pitch 151 corresponds to one circumference of the insulation electric wire 10 that is wound helically around the center 152 of the twist, and indicates the length of the insulation electric wire 10 in the longitudinal direction. Further, the outer diameter of the insulation electric wire 10 indicates a diameter of a circle being a cross-section of the insulation electric wire 10, which is vertical to the longitudinal direction.

Moreover, it is preferred that the difference in length per meter between the two insulation electric wires 10 be 3 mm or less. When the difference in length per meter is 3 mm or less, degradation of characteristics of mode conversion relating to emission or resistance to electrical noise can be prevented.

The insulation electric wire 10 may be formed by a publicly known method, and may be produced by a general extrusion molding method, for example. Specifically, the material of the covering layer 12 is extruded to cover the outer surface of the conductor 11 formed of one or a plurality of wires. In this manner, the covering layer 12 may be formed.

As described above, the communication cable 100 includes the insulation electric wire 10 including the conductor 11 having tensile strength of 400 MPa or more and a cross-sectional area of 0.22 mm² or less and the covering layer 12 covering the conductor 11 and being formed of the insulating material. Further, the communication cable 100 includes the sheath 20 covering the outer periphery of the insulation electric wire 10 and being formed of the resin composition containing the crystalline polyolefin. The tensile elastic modulus of the sheath 20 is 500 MPa or less, the mass increase rate of the sheath 20 is less than 50 mass % in the plasticizer migration test in which the communication cable 100 and the polyvinyl chloride electric wire 110 are bundled together and left in an atmosphere at 105° C. for 3,000 hours. Further, the characteristic impedance of the communication cable 100 is 100±10Ω. Therefore, it is possible to provide the communication cable 100 that has higher flexibility and a further excellent communication property and is not likely to cause degradation of a transmission property by suppressing migration of a plasticizer from another member even in a high-temperature atmosphere for an extended period, and a wire harness using the same.

### [Wire Harness]

As illustrated in FIG. 3, the wire harness 200 according to the present embodiment includes the communication cable 100 and the polyvinyl chloride electric wire 110, and the communication cable 100 and the polyvinyl chloride electric wire 110 are bundled together. The communication cable 100 and the polyvinyl chloride electric wire 110 are electrically connected to a connector 120. The plasticizer is less likely to migrate to the sheath 20 described above, and hence migration of the plasticizer to the sheath 20 and the covering layer 12 of the insulation electric wire 10 can be suppressed even when the plasticizer is contained in the insulating material of the polyvinyl chloride electric wire 110. Therefore, in the wire harness 200, the communication cable 100 and the low-cost and highly flexible polyvinyl chloride electric wire 110 can be bundled together.

The polyvinyl chloride electric wire 110 may include a conductor and a covering layer. The similar shape and material of the conductor 11 of the insulation electric wire 10 described above are applicable to the conductor of the polyvinyl chloride electric wire 110. The similar shape and material of the covering layer 12 of the insulation electric wire 10 described above are applicable to the covering layer of the polyvinyl chloride electric wire 110. The covering layer of the polyvinyl chloride electric wire 110 may contain a plasticizer in addition to polyvinyl chloride. As the plasticizer, a publicly known plasticizer added to polyvinyl chloride may be used. The plasticizer may be at least one type selected from a group consisting of a trimellitic acid-based plasticizer, a aliphatic dibasic acid-based plasticizer, an epoxy-based plasticizer, a phthalic acid-based plasticizer, a pyromellitic acid ester-based plasticizer, a phosphoric ester-based plasticizer, and an ether ester-based plasticizer.

The phthalic acid-based plasticizer may be at least one type of phthalate ester selected from a group consisting of di(2-ethylhexyl) phthalate (DEHP), di-n-octyl-phthalate (DNOP), diisononyl phthalate (DINP), dinonyl phthalate (DNP), diisodecyl phthalate (DIDP), and ditridecyl phthalate (DTDP).

For example, the trimellitic acid-based plasticizer may be one type of trimellitic acid ester selected from a group consisting of trioctyl trimellitate (TOTM) and triisodecyl trimellitate.

### Examples

The present embodiment is further described below in detail with Example and Comparative Example, but the present embodiment is not limited to those examples.

In Example 1, a method of producing a conductor was as described below. First, solid solution strengthening was performed by adding 0.3 mass % of tin to pure copper through use of a continuous casting machine, work hardening was performed by applying processing strain through wire drawing processing, and wire drawing was performed until a wire diameter of 0.168±0.03 mm was obtained. Then, seven wires thus obtained were used to perform twisting processing at a twist pitch of 16 mm and compression molding, and then a circular compression conductor was obtained. The conductor thus obtained had a conductor cross-sectional area of 0.13 mm² and an outer diameter of 0.46 mm.

The tensile strength and the breaking elongation of the copper alloy thus obtained were evaluated in accordance with JIS Z2241. In this case, a rating distance was 250 mm, and a tensile speed was 50 mm/min. As a result of the evaluation, the tensile strength was 760 MPa, and the breaking elongation was 3%.

Meanwhile, in Comparative Example 1, a method of producing a conductor was as described below. In Comparative Example 1, a copper alloy conductor was produced by a method similar to that in Example 1, except that compression molding was not performed and a circular conductor was obtained. The conductor cross-sectional area was 0.13 mm², and the outer diameter was 0.48 mm. Further, as a result of performing the evaluation similar to that in Example 1, the tensile strength of the conductor was 790 MPa, and the breaking elongation thereof was 3%.

With regard to insulating materials forming covering layers in Example 1 and Comparative Example 1, in accordance with blending ratios (parts by mass) of resin compositions shown in Table 1, the above-mentioned raw materials for production were blended and kneaded by a continuous kneading machine. In this manner, resin pellets were produced. Then, the resin pellets were put into an extruding machine in which the copper alloy conductor in Example 1 or Comparative Example 1 was set, and the copper alloy conductor was covered with a covering layer through extrusion molding. In this manner, two insulation electric wires specified in ISO 21111-8 were produced.

Subsequently, the insulation electric wires in Example 1 and Comparative Example 1 were used to form twist pairs at a twist pitch of 30 mm. Then, similarly to the method of producing the insulation electric wire, covering with a sheath, which was obtained in accordance with blending amounts (parts by mass) of resin compositions shown in Table 2, was performed through extrusion molding. In this manner, a communication cable was produced without generating a gap between the sheath and the insulation electric wire. Note that the thickness of the covering layer, the finish outer diameter of the insulation electric wire, the thickness of the sheath, and the finish outer diameter of the communication cable are as shown in Table 3. In a case of Example 1, the twist pitch of the insulation electric wire was 35 times of the outer diameter of the insulation electric wire. In a case of Comparative Example 1, the twist pitch of the insulation electric wire was 33 times of the outer diameter of the insulation electric wire.

TABLE 1

| | | | | Comparative |
|---|---|---|---|---|
| | | | Example 1 | example 1 |
| | | | Covering layer | |
| Polypropylene | Block PP | E150GK | 70 | — |
| Flexible resin | LDPE | 3530 | 15 | — |
| | Cross-linked polyethylene | — | — | 100 |
| | Thermoplastic vulcanizate | 1200B | — | — |
| | Modified SEBS | M1943 | 15 | — |
| Flame Retardant | Magnesium hydroxide | YG-O | 37.5 | — |
| | Bromine-base flame retardant | 8010 | 30 | — |
| Flame Retardant Promoter | Antimony trioxide | PATOX-M | 10 | — |
| Antioxidant | Phenol-based | AO-20 | 6 | — |
| | Hindered phenol-based | 1010 | — | 0.01 |
| Processing Promoter | Metal soap | EMS-6P | 0.5 | — |
| | Acrylic polymer lubricant | P1050 | 5 | — |
| Inorganic Filler | Titanium oxide | CR-63 | 38 | — |
| Metal Deactivator | Salicylic acid-based amide compound | CDA-1 | 1 | — |

TABLE 2

| | | | | Comparative |
|---|---|---|---|---|
| | | | Example 1 | example 1 |
| | | | Sheath | |
| Crystalline polyolefin | Block PP | E150GK | 35 | — |
| | LDPE | 3530 | 35 | — |
| | Mixture of polypropylene (PP)/ | — | — | 100 |
| | EVA (60 wt %/40 wt %) | | | |
| Thermoplastic elastomer | Thermoplastic vulcanizate | 1200B | 15 | — |
| | Modified SEBS | M1943 | 15 | — |
| Flame Retardant | Magnesium hydroxide | YG-O | 80 | 145 |
| | Bromine-based flame retardant | 8010 | 30 | — |
| Flame Retardant Promoter | Antimony trioxide | PATOX-M | 10 | — |
| Antioxidant | Phenol-based | AO-20 | 8 | — |
| | Hindered phenol-based | 1010 | — | 0.253 |
| | | 1076 | — | 0.01 or less |
| | | 168 | — | 0.01 or less |
| Processing Promoter | Metal soap | EMS-6P | 0.5 | — |
| | Acrylic polymer lubricant | P1050 | 5 | — |

TABLE 3

| | | | | Comparative | Comparative |
|---|---|---|---|---|---|
| | | | Example 1 | example 1 | example 2 |
| Insulation electric wire | Covering layer | Thickness (mm) | 0.20 | 0.21 | 0.20 |
| | — | Finish outer diameter (mm) | 0.86 | 0.90 | 0.85 |
| Communication cable | Sheath | Thickness (mm) | 0.39 | 0.35 | 0.75 |
| | — | Finish outer diameter (mm) | 2.5 | 2.5 | 3.2 |

### [Resin]

Block polypropylene (block PP): available from Prime Polymer Co., Ltd., Product name: Prime Polypro (registered trademark) E150GK
Low-density polyethylene (LDPE): available from Dow-Mitsui Polychemicals Co., Ltd., Product name: MIRASON (registered trademark) 3530
Mixture of polypropylene (PP)/EVA (60 wt %/40 wt %)
Cross-linked polyethylene
Thermoplastic vulcanizate: JSR Corporation, Product name: EXCELINK (registered trademark) 1200B
Maleic acid anhydride-modified polystyrene-poly(ethylene-butylene)-polystyrene (modified SEBS): available from Asahi Kasei Corporation, Product name: Tuftec (registered trademark) M1943

### [Flame Retardant]

### (Metal Hydroxide)

Magnesium hydroxide (Mg(OH)₂): available from Konoshima Chemical Co., Ltd., Product name: YG-O (halogen-based flame retardant)
Bromine-based flame retardant (1,2-bis(pentabromophenyl)ethane): available from Albemarle Corporation, Product name: SAYTEX (registered trademark) 8010

### [Flame Retardant Promoter]

Antimony trioxide (Sb₂O₃): available from NIHON SEIKO CO., LTD., Product name: PATOX (registered trademark) M

### [Antioxidant]

Phenol-based antioxidant: available from ADEKA Corporation, Product name: ADK STAB (registered trademark) AO-20
Hindered phenol-based antioxidant: available from BASF SE, Product name: Irganox (registered trademark) 1010
Hindered phenol-based antioxidant: available from BASF SE, Product name: Irganox 076
Phosphorus-based antioxidant: available from BASF SE, Product name: Irgafos (registered trademark) 168

### [Processing Promoter]

Metal soap: available from KATSUTA KAKO CO., LTD., Product name: EMS-6P
Acrylic polymer lubricant: available from Mitsubishi Chemical Corporation, Product name: METABLEN (registered trademark) P-1050

### [Inorganic Filler]

Titanium oxide: available from ISHIHARA SANGYO KAISHA, LTD., Product name: TIPAQUE (registered trademark) CR-63

### [Metal Deactivator]

Salicylic acid-based amide compound: available from ADEKA Corporation, Product name: ADK STAB (registered trademark) CDA-1

### [Evaluations]

### (Characteristic Impedance)

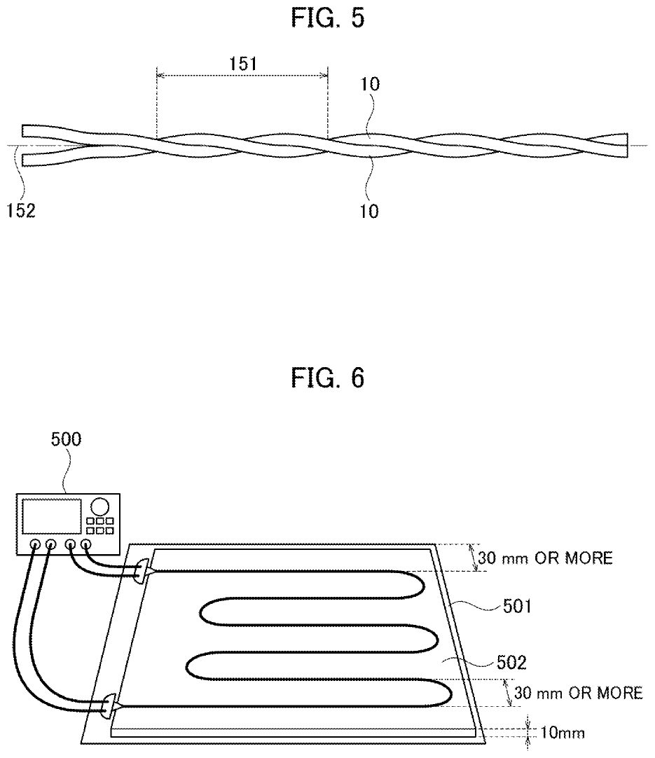

With regard to the communication cables thus produced as described above in Example 1 and Comparative Example 1, characteristic impedance was measured through use of a vector network analyzer (VNA) (available from Keysight Technologies, E5071C) 500 as described in FIG. 6. Test samples each having a length of 10 m were prepared for the communication cables in Example 1 and Comparative Example 1. A plate formed of a dielectric (foaming material) 502 having a specific dielectric constant of 1.4 or less was placed on a metal plate 501, and then the test samples were placed thereon. The test samples were placed at an interval of 30 mm or more between the test samples, and were placed on the inner side from the end of the metal plate 501 by 30 mm or more. Further, the test samples were connected to a measurement substrate adjusted to have 100Ω, a rectangular wave with a rise time of 700 ps was applied thereto, and then characteristic impedance was measured.

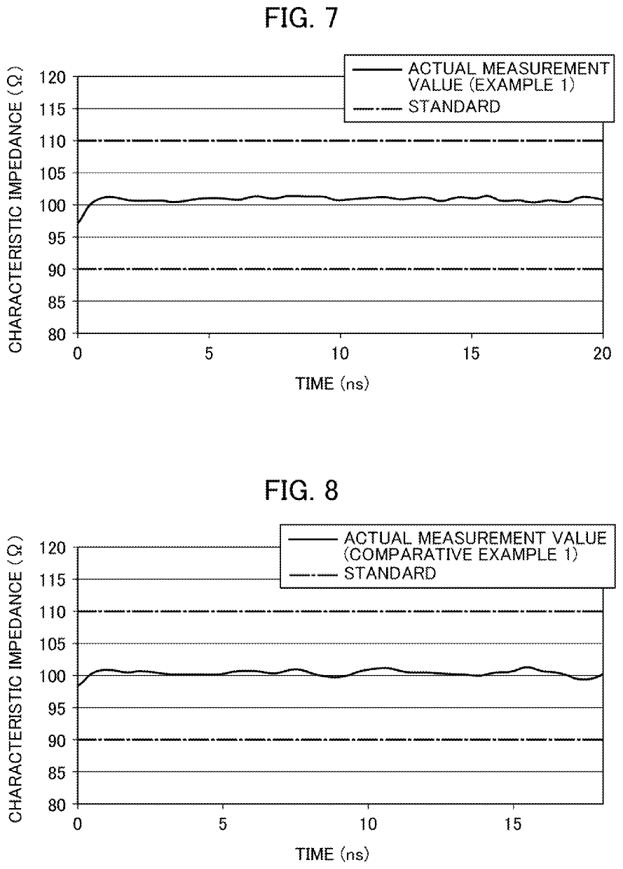

FIG. 7 is a graph illustrating the characteristic impedance of the communication cable in Example 1. FIG. 8 is a graph illustrating the characteristic impedance of the communication cable in Comparative Example 1. It can be understood that both Example 1 and Comparative Example 1 fell within a range of a standard value of the characteristic impedance (100±10Ω).

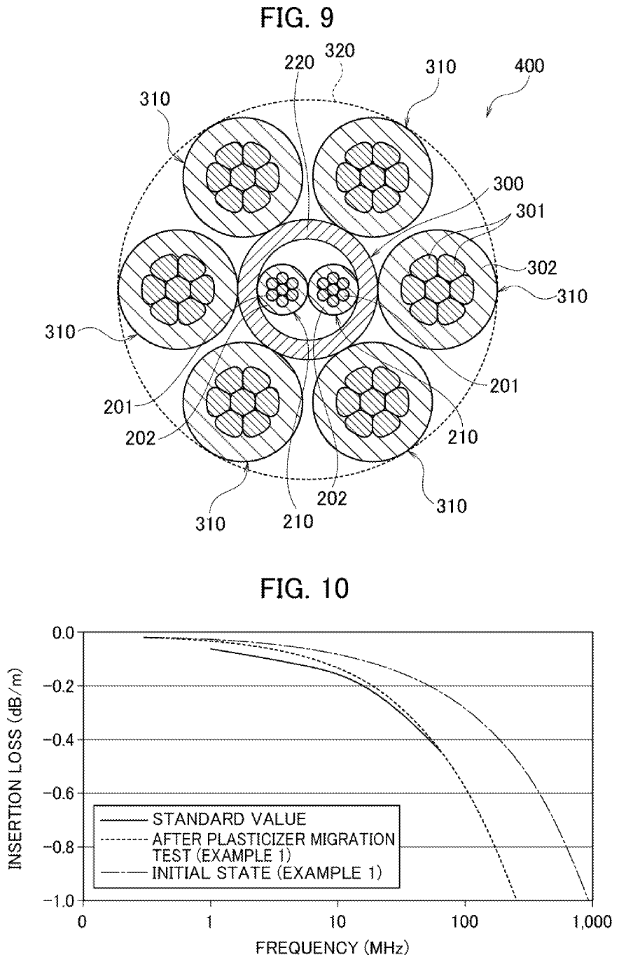

As illustrated in FIG. 9, the communication cable 300 was formed so that a gap was generated between outer surfaces of two insulation electric wires 210 and a sheath 220. Conditions other than this were the same as the methods of producing a communication cable in Example 1 and Comparative Example 1. In the insulation electric wire 210, a conductor 201 having a cross-sectional area of 0.13 mm² was covered with a covering layer 202. Meanwhile, a polyvinyl chloride electric wire 310 includes a plurality of conductors 301 and a covering layer 302 covering the peripheries of the conductors 301. The covering layer 302 contains polyvinyl chloride and a plasticizer.

As illustrated in FIG. 9, six polyvinyl chloride electric wires 310 were arranged to surround the periphery of the communication cable 300 with the communication cable 300 in Example 1 or Comparative Example 1 as a center. Further, a polyvinyl chloride tape 320 was wound around the periphery of the polyvinyl chloride electric wire 310 to produce a test sample 400.

### (Plasticizer Migration Test)

A plasticizer migration test was performed to examine how migration of the plasticizer, which was added to the polyvinyl chloride electric wire 310, to the sheath 220 affected the communication cable 300. The test sample 400 thus produced in Example 1 or Comparative Example 1 as described above was heated in an oven at 105° C. for 3,000 hours, was taken out from the oven, and then was left at a room temperature for a while.

### (Insertion Loss)

An influence on an insertion loss of the communication cable 300 before and after the plasticizer migration test was examined. As illustrated in FIG. 6, an insertion loss of the communication cable 300 in each of Example 1 and Comparative Example 1 before and after the plasticizer migration test was measured through use of the VNA under conditions of a measurement frequency from 300 kHz to 1,000 MHz and a measurement bandwidth of 100 Hz.

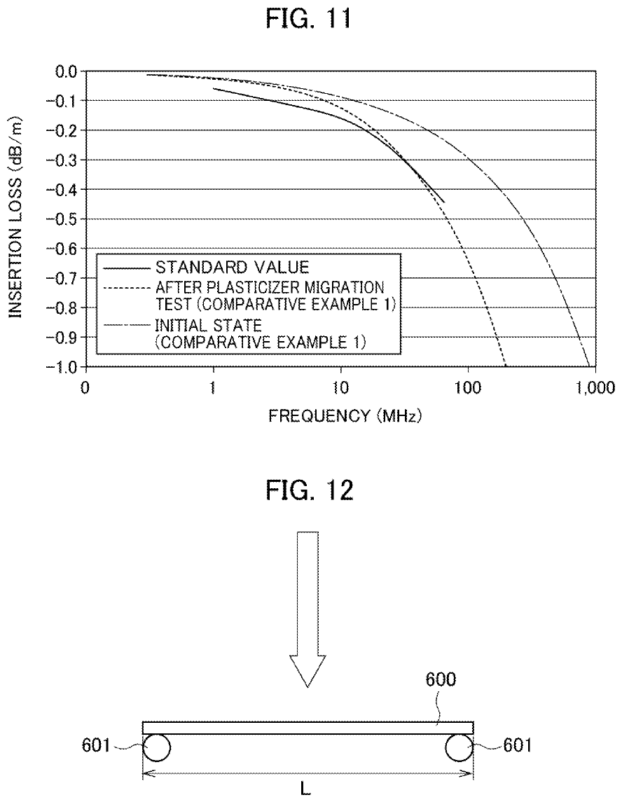

FIG. 10 is a graph illustrating an insertion loss of the communication cable in Example 1 before and after the plasticizer migration test. FIG. 11 is a graph illustrating an insertion loss of the communication cable in Comparative Example 1 before and after the plasticizer migration test. As shown in FIG. 10 and FIG. 11, before the plasticizer migration test (at the initial stage), both Example 1 and Comparative Example 1 exceeded the standard value of the insertion loss. However, as the frequency was higher, the insertion loss was reduced. Further, after the plasticizer migration test, as the frequency was higher, the insertion loss was further significantly reduced as compared to the initial stage. However, in the communication cable in Example 1, reduction of the insertion loss was suppressed as compared to the communication cable in Comparative Example 1, and the standard value was satisfied. Thus, the communication cable in Example 1 was regarded to have a sufficient communication property. In contrast, in the communication cable in Comparative Example 1, the standard value was not satisfied. There may be a risk that a communication property in a high frequency range is reduced and a required insertion loss is not sufficiently satisfied at the time of use at a high temperature for an extended period, for example, in a vehicle.

### (Dielectric Property)

Table 4 shows measurement results of a specific dielectric constant and a dielectric tangent of the resin composition of the sheath before and after the plasticizer migration test. Further, Table 4 shows measurement results of a specific dielectric constant and a dielectric tangent of the insulating material forming the covering layer before the plasticizer migration test (at the initial stage). Specifically, the test sample before and after the plasticizer migration test was cut out vertically with respect to the longitudinal direction of the communication cable so as to have a length of 150 mm, and the conductor and the covering layer were removed from the cut cable. In this manner, the sample with only the sheath was prepared. Further, a specific dielectric constant and a dielectric tangent of the test sample were measured by the cavity resonator method through use of a specific dielectric constant measurement device (available from AET, INC., ADMS01Nc). The specific dielectric constant and the dielectric tangent were measured at a frequency of 10 GHz in an atmosphere at 30° C. As shown in Table 4, in both Example 1 and Comparative Example 1, the specific dielectric constant and the dielectric tangent of the resin composition of the sheath after the plasticizer migration test showed an increasing trend as compared to those before the plasticizer migration test (at the initial stage).

TABLE 4

| | | Example 1 | | Comparative example 1 | |
|---|---|---|---|---|---|
| | | | Covering | | Covering |
| | | Sheath | layer | Sheath | layer |
| Specific dielectric constant | Initial stage | 3.02 | 2.8 | 4.09 | 2.3 |
| [measurement frequency of 10 GHz] | After plasticizer migration test | 3.43 | — | 4.40 | — |
| Dielectric tangent [measurement | Initial stage | 9.3 × 10⁻⁴ | 1.6 × 10⁻³ | 3.8 × 10⁻³ | 1.3 × 10⁻³ |
| frequency of 10 GHz] | After plasticizer migration test | 2.3 × 10⁻³ | — | 9.0 × 10⁻³ | — |
| Mass of sheath (with initial value | Initial stage | 100 | — | 100 | — |
| of 100) | After plasticizer migration test | 110.05 | — | 188.09 | — |
| Mass increase rate (mass %) | After plasticizer migration test | 9.1 | — | 46.8 | — |
| Tensile elastic modulus (MPa) | Initial stage | 311.4 | — | 283.5 | — |

### (Mass Increase Rate)

In the communication cables in Example 1 and Comparative Example 1, a state in which the plasticizer added to the polyvinyl chloride electric wire migrated to the sheath was observed. Table 4 shows measurement results of a mass of the sheath before and after the plasticizer migration test and a mass increase rate of the sheath after the plasticizer migration test.

In order to calculate the mass increase rate, the sheath was peeled off from the communication cable produced as described above, and was immersed in a container filled with DINP. After the sheath was immersed in an oven at 105° C. for 3,000 hours, the sheath was taken out from the container, and the DINP adhering to the surface of the sheath was wiped off. The mass of the sheath before and after DINP immersion was measured, and the mass increase rate was calculated in the following manner. As the DINP, a product available from J-PLUS Co., Ltd. was used.

Note that the mass increase rate can be obtained based on Calculation Formula (3) given below.

$$Mass increase rate ( mass \% ) = ( ( Mass after immersion ) / ( Mass before immersion ) - 1 ) \times 100 \qquad ( 3 )$$

As shown in Table 4, it can be understood that the mass increase rate of the sheath after the plasticizer migration test in Comparative Example 1 was significantly higher than that in Example 1. Thus, it can be understood that the plasticizer added to the polyvinyl chloride electric wire easily migrates to the sheath when the communication cable in Comparative Example 1 is used at a high temperature for an extended period, for example, in a vehicle.

Based on those results, the plasticizer contained in the covering layer of the polyvinyl chloride electric wire was regarded as a factor for causing reduction of the insertion loss. Thus, the sheath to which the plasticizer was less likely to migrate was developed. As a result, in the communication cable in Example 1, the plasticizer was less likely to migrate, and reduction of the insertion loss was successfully suppressed.

### (Tensile Elastic Modulus)

The sheaths were peeled off from the communication cables thus produced in Example 1 and Comparative Example 1. The sheath thus peeled off was pulled at a tensile speed of 50 mm/min at a room temperature of 20° C. in accordance with the provisions of JIS K7161-1. Further, a tensile elastic modulus was calculated based on a stress of 0.00005 and a stress of 0.0025 for the sheath.

As shown in Table 4, in both Example 1 and Comparative Example 1, the tensile elastic modulus of the sheath before the plasticizer migration test (at the initial stage) was 500 MPa or less, and hence it can be understood that operability of routing of the communication cable was excellent.

In the communication cable in Example 1, it can be understood that the tensile elastic modulus and the mass increase rate of the sheath were predetermined values or less, flexibility was higher, and migration of the plasticizer from another member was suppressed even in a high-temperature atmosphere for an extended period. In contrast, in the communication cable in Comparative Example 1, the tensile elastic modulus of the sheath was the predetermined value or less while the mass increase rate was not the predetermined value or less, and hence it is considered that migration of the plasticizer from another member was not suppressed in a high-temperature atmosphere for an extended period.

In Comparative Example 2, a method of producing a conductor was as described below. In Comparative Example 2, a copper alloy conductor was produced by a method similar to that in the Example 1. The conductor cross-sectional area was 0.13 mm², and the outer diameter was 0.48 mm. Further, as a result of the evaluation similar to that in Example 1, the tensile strength the conductor was 750 MPa, and the breaking elongation was 3%.

The conductor in Comparative Example 2 was covered with a covering layer formed of an olefin-based resin through extrusion molding, and two insulation electric wires specified in ISO 21111-8 were produced. Then, covering with a sheath formed of an olefin-based resin was performed through extrusion molding to obtain a communication cable. Note that the thickness of the covering layer, the finish outer diameter of the insulation electric wire, the thickness of the sheath, and the finish outer diameter of the communication cable are as shown in Table 3.

### (Flexibility of Communication Cable)

Each of the communication cables thus produced in Example 1, Comparative Example 1, and Comparative Example 2 was cut out vertically with respect to the longitudinal direction of the communication cable to have a length of 100 mm. In this manner, a test sample was produced. Subsequently, as illustrated in FIG. 12, both ends of a test sample 600 having a length L of 100 mm were placed on a support table 601. Further, a load was applied at a speed of 100 mm/min to the center of the test sample 600, and a maximum load at which the electric wire fell was measured through use of a force gauge. A target range of flexibility of the communication cable was set to a force gauge value of 2.0 N or less, and evaluation was performed.

### (DINP Absorption Amount)

The sheath was peeled off from each of the communication cables produced as described above in Example 1, Comparative Example 1, and Comparative Example 2, and was immersed in a container filled with DINP (available from J-PLUS Co., Ltd.). After the sheath was immersed in an oven at 100° C. for 72 hours, the sheath was taken out from the container, and the DINP adhering to the surface of the sheath was wiped off. The mass of the sheath before and after DINP immersion was measured, and a DINP absorption amount was calculated in the following manner. A target range of the DINP absorption value of the sheath was set to 20 mass % or less, and evaluation was performed.

Note that the DINP absorption amount can be obtained based on Calculation Formula (4) given below.

$$DINP absorption amount ( mass \% ) = ( Mass of sheath after immersion - Mass of sheath before immersion ) / Mass of sheath before immersion \times 100 \qquad ( 4 )$$

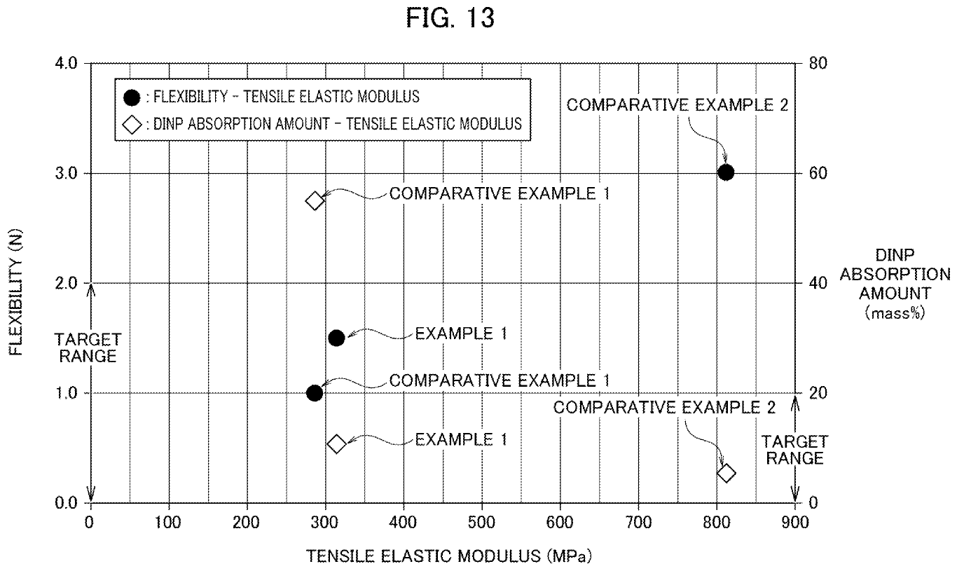

FIG. 13 and Table 5 show a relationship between flexibility of the communication cable and the DINP absorption amount of the sheath with respect to the tensile elastic modulus of the sheath in each of the communication cables in Example 1, Comparative Example 1, and Comparative Example 2. In the communication cable in Example 1, the tensile elastic modulus of the sheath was 500 MPa or less, flexibility of the communication cable was 2.0 N or less, and the DINP absorption amount was 20 mass % or less. Thus, the communication cable having excellent flexibility and a small absorption amount of the plasticizer was obtained.

TABLE 5

| | | Comparative | Comparative |
|---|---|---|---|
| | Example 1 | example 1 | example 2 |
| Tensile elastic modulus | 311.4 | 283.5 | 806.7 |
| (MPa) | | | |
| DINP absorption amount | 10.5 | 55.4 | 5.4 |
| (mass %) | | | |
| Flexibility of | 1.5 | 1.0 | 3.0 |
| communication cable (N) | | | |

In contrast, in the communication cable in Comparative Example 1, the tensile elastic modulus of the sheath was 500 MPa or less, flexibility of the communication cable was 2.0 N or less, but the DINP absorption amount was more than 20 mass %. Thus, flexibility was excellent, but an absorption amount of the plasticizer was regarded to be high. Further, in the communication cable in Comparative Example 2, the DINP absorption amount was 20 mass % or less. However, the tensile elastic modulus of the sheath was more than 500 MPa, and flexibility of the communication cable was more than 2.0 N. Thus, an absorption amount of the plasticizer was small, but flexibility and operability of routing were regarded to be inferior.

In general, a hard material has high resin crystallinity, and hence an absorption amount of the plasticizer is small. In contrast, a soft material has low crystallinity or contains a flexible component, and hence an absorption amount of the plasticizer is large. In the communication cable in Example 1, an absorption amount of the plasticizer was successfully suppressed low while improving flexibility. Based on the above observations, the communication cable in Example 1 was a communication cable that had high flexibility and an excellent communication property and was not likely to cause degradation of a transmission property by suppressing migration of the plasticizer from another member even in a high-temperature atmosphere for an extended period. Note that the DINP used for evaluation on an absorption amount of the plasticizer was a typical plasticizer, and it is considered that a similar tendency is also observed in a case of a plasticizer used for different polyvinyl chloride.

The present embodiment is described above with the example. However, the present embodiment is not limited thereto, and various modifications may be made within the gist of the present embodiment.

The entire contents in Japanese Patent Application No. 2021-205278 (filed on Dec. 17, 2021) are herein invoked.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A communication cable, comprising:
an insulation electric wire including a conductor having tensile strength of 400 MPa or more and a cross-sectional area of 0.22 mm² or less and a covering layer covering the conductor and being formed of an insulating material; and
a sheath covering an outer periphery of the insulation electric wire and being formed of a resin composition containing crystalline polyolefin, wherein
the insulating material contains polypropylene and a flexible resin, and a content rate of the polypropylene with respect to a total of the polypropylene and the flexible resin is 51 mass % or more and 85 mass % or less,
the insulating material contains 15 to 60 parts by mass of titanium oxide, 10 to 80 parts by mass of a bromine-based flame retardant, and less than 45 parts by mass of magnesium hydroxide with respect to a total of 100 parts by mass of the polypropylene and the flexible resin,
a tensile elastic modulus of the sheath is 500 MPa or less,
a mass increase rate of the sheath is less than 50 mass % in a plasticizer migration test involving exposure in an atmosphere at 105° C. for 3,000 hours, and
characteristic impedance is 100±10Ω.

2. The communication cable according to claim 1, wherein
the resin composition contains the crystalline polyolefin and a thermoplastic elastomer, and a content rate of the crystalline polyolefin with respect to a total of the crystalline polyolefin and the thermoplastic elastomer is 55 mass % or more and 70 mass % or less.

3. The communication cable according to claim 2, wherein
the resin composition contains 40 to 150 parts by mass of metal hydroxide and 10 to 30 parts by mass of a halogen-based flame retardant with respect to a total of 100 parts by mass of the crystalline polyolefin and the thermoplastic elastomer,
a specific dielectric constant of the resin composition is 6 or less, and
a dielectric tangent of the resin composition is 5×10⁻² or less.

4. The communication cable according to claim 1, wherein
a specific dielectric constant of the insulating material is 2.25 or greater and 3.5 or less.

5. The communication cable according to claim 1, wherein
a twist pitch of the insulation electric wire is 15 times or more or 45 times or less of an outer diameter of the insulation electric wire.

6. The communication cable according to claim 1, wherein
a thickness of the covering layer is 0.32 mm or less.

7. A wire harness, comprising:
the communication cable according to claim 1; and
a polyvinyl chloride electric wire, wherein
the communication cable and the polyvinyl chloride electric wire are bundle together.
